(19) United States
(12) Patent Application Publication
(10) Pub. No.: US 2023/0335312 A1
(43) Pub. Date: Oct. 19, 2023

(54) An Electric Vehicle Charging Cable and a Method of Making

(71) Applicants: Ran Sagiv, Haifa (IL); GREEN BUSINESS DEVELOPMENT LTD., Haifa (IL)

(72) Inventors: Shalom Green, Haifa (IL); Nimrod Ginzberg, Haifa (IL)

(73) Assignees: Ran Sagiv, Haifa (IL); GREEN BUSINESS DEVELOPMENT LTD, Haifa (IL)

(21) Appl. No.: 18/027,136

(22) PCT Filed: Sep. 3, 2021
(86) PCT No.: PCT/IL2021/051082

§ 371 Date: Mar. 20, 2023

(30) Foreign Application Priority Data
Oct. 15, 2020 (IL) 278084

(51) Int. Cl. H01B 7/42; H01B 13/00; H01B 9/00; B60L 53/16; B60L 53/18

(52) U.S. Cl. CPC H01B 7/421; H01B 13/0036; H01B 9/006; B60L 53/16; B60L 53/18

(57) ABSTRACT

An electric vehicle charging cable that includes two, three, four or more positive conductors and same number of negative conductors that are capable to conduct current at a certain value. The total cross-sectional areas of the conductors is equal or smaller than a total cross-sectional areas of hypothetical single positive and negative conductors that are capable to conduct current at that certain value.

### TECHNICAL FIELD

The present invention relates to an electric vehicle charging cable and a method of making it in an improved cost performance way.

### BACKGROUND ART

The world is moving towards electric cars that present increasing number of cars with longer travelling range. As a result, the demand for fast charging increases. Fast charging requires the ability to deliver higher current in a short time period. Fast charging cables are becoming too heavy and less flexible due to the increase in cross section, required to deliver high currents. Winding 35 mm² or even 25 mm² on a drum is complicated and the issue of cable flexibility plays an important role. The maximum current allowed through a conductor depends on its cross section. The larger the cross section the higher is the permitted current carrying capacity. In AC systems, the current travels near the surface of the wire due to the skin effect. Consequently, the higher the cable perimeter the better is the heat dissipation, and hence the higher the current delivery. This highlights an additional parameter regarding a conductor definition, which is the ratio between the conductor perimeter and the cross-sectional area. The chart in FIG. 1A shows that small cross section presents better P/A ration (Perimeter/Area) and shows that smaller conductors have advantages over large ones in terms of this ratio. The vertical column in the chart of FIG. 1 represents the P/A ratio and the horizontal column the cross section in mm². The present invention discloses an electric vehicle charging cable and a method of making it.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1A is a chart that shows that smaller conductors have advantages over large ones in terms of this ratio.

FIG. 1B is a chart that illustrates the advantages of the method and the cable.

FIG. 2 schematically illustrates the cable 10.

FIG. 3 schematically illustrates three positive conductors 11.

FIG. 4 schematically illustrates three negative conductors 12.

FIG. 5 schematically illustrates the cross sectional areas 11a and 12a.

FIG. 6 schematically illustrates the hypothetical single positive and negative conductors 13 and 14 and their cross sectional areas 13a and 14a.

FIG. 7 schematically illustrates the cable 20.

FIGS. 8A, 8C and 8D schematically illustrate a cross section of the cable 20 when it is a three-phase line.

FIG. 8B schematically illustrates a cross section of the cable 20 when it is a single-phase line.

FIG. 9 schematically illustrates a cross section of a phase line 22.

FIG. 10 schematically illustrates three conductors 23.

FIG. 11 schematically illustrates the hypothetical conductor 24 and its cross-sectional area 24a.

FIG. 12 illustrates a cross section of a standard three-phase line cable.

### THE INVENTION

The main object of the present invention is to provide an electric vehicle charging cable and a method of making the cable.

The innovation suggests to replace each conductor with several smaller-in-size conductors (2, 3, 4, etc.) to obtain a better cable design. In general, we can show that dividing a phase conductor by a factor of N yields a higher overall conductor perimeter, which implicates better heat dissipation, higher current carrying capacity, and better cable flexibility. The improvement is in the order of square root of “N” (see below). For example, dividing each phase conductor cross section by N=2 yields a total perimeter that is 41% longer.

Similarly, dividing by N=3 yields a perimeter increase of 73%, and dividing by N=4 presents a 100% increase. These findings are highly significant as we propose a method to increase the effective conducting area within the conductors, thereby increasing the current rating, heat dissipation, and flexibility. Note that not all cross sections are allowed by the electric code. Therefore, the replacement will be made in a way that is allowed by the relevant electric code. According to the international standard IEC 1516 only 2.5, 4, 6, 10, 16, 25 mm² etc. cross sections are allowed.

$${A}_{ref} = π {r}_{ref}^{2} \qquad ( 1 )$$

$${A}_{new} = \frac{1}{n} {A}_{ref} \qquad ( 2 )$$

$${r}_{new} = \sqrt{\frac{{A}_{new}}{π}} = \sqrt{\frac{\frac{1}{n} π {r}_{ref}^{2}}{π}} = \frac{{r}_{ref}}{\sqrt{n}} \qquad ( 3 )$$

$${C}_{new} = 2 π {r}_{new} \cdot n = n \frac{2 π {r}_{ref}}{\sqrt{n}} = 2 π {r}_{ref} \sqrt{n} = {C}_{ref} \sqrt{n} \qquad ( 4 )$$

$$\frac{{C}_{new}}{{C}_{ref}} = \sqrt{n} \qquad ( 5 )$$

For example:
A phase conductor of 10 mm² in cross section can be replaced by 2 conductors of 4 mm² and also by 3 or 4 conductors of 2.5 mm².
A phase conductor of 25 mm² in cross section can be replaced by 2 conductors of 10 mm² and also by 4 conductors of 6 mm².
A phase conductor of 35 mm² in cross section can be replaced by 2 conductors of 16 mm² and also by 3 conductors of 10 mm²

The following chart shows several valid configurations according to the proposed system:

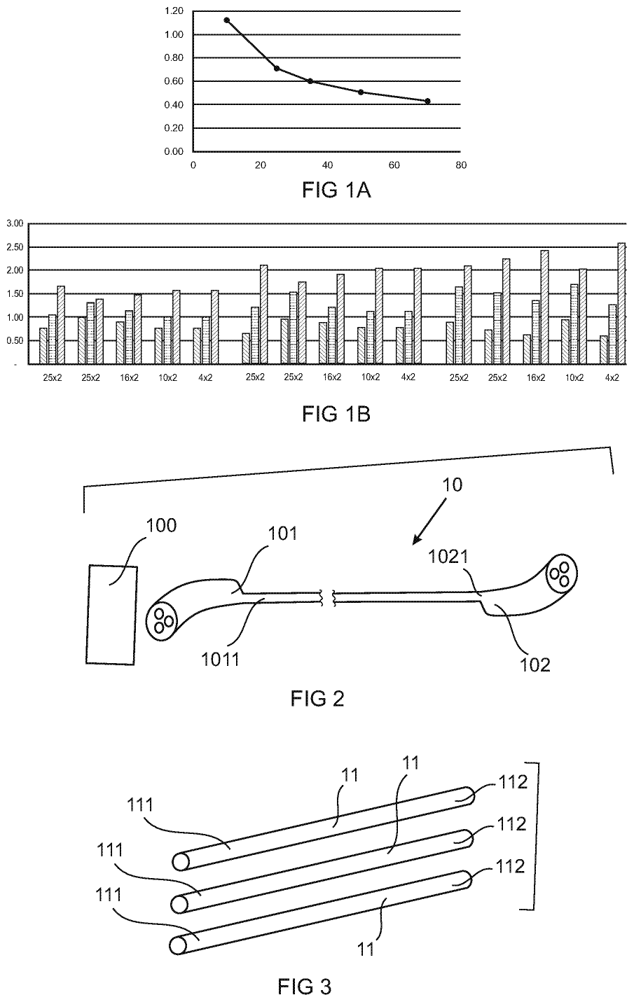

FIG. 1B illustrates the advantages of using the method and the cable subject matter of the invention and shows that the followings will be achieved: (a) less conductive material. All configurations show copper usage ratio (Left column in the figure) that is smaller than one and therefore presents conductive material savings in both costs and weight. (b) Higher Current Rating (Middle column in the figure). All configurations show current rating ratio that is higher than one and therefore present a better cost-effective cable. (c) P/A ratio (Right column in the figure). All configurations show increased ratio, which physically enable better heat dissipation and lower steady state temperature and improved current rating.

In addition, based on the above-mentioned findings we claim that: (a) a power cable built in this method will be lighter due to less conductive material. (b) a power cable built in this method will be more flexible preferable for drum design, portable applications, bending radius and more.

As stated above, the object of the present invention is to provide a method of making an electric vehicle charging cable (10) that is designed to conduct direct current at a certain value. The method includes the followings:
(a) providing two, three, four or more positive conductors (11) and same number of negative conductors (12), wherein said positive conductors and said negative conductors are together capable and appropriate to conduct direct current at at least said certain value;
(b) preparing the electric vehicle charging cable, inter alia, from the positive conductors and the negative conductors;
(c) wherein a total cross-sectional areas of the positive conductors (11a) and of the negative conductors (12a) is equal or smaller than a total cross-sectional areas (13a) (14a) of hypothetical single positive conductor and (13) of hypothetical single negative conductor (14) that together are capable and appropriate to conduct direct current at said at least certain value;
(d) wherein a total weight of the positive conductors together with the negative conductors of a given length is equal or smaller than a total weight of the hypothetical single positive conductor together with the single negative conductor of said given length;
(e) wherein a steady state temperature of the cable that contains the positive conductors and of the negative conductors while transmitting a certain level of current for a certain period of time is lower than hypothetical steady state temperature of a hypothetical cable that comprises the single positive conductor and the single negative conductor while transmitting said certain level of current for said certain period of time;
(f) wherein first ends (111) of said positive conductors are connected together at a first end (101) of the electric vehicle charging cable and second ends (112) of said positive conductors are connected together at a second end (102) of the electric vehicle charging cable; wherein first ends (121) of said negative conductors are connected together at said first end of the electric vehicle charging cable and second ends (122) of said negative conductors are connected together at said second end of the electric vehicle charging cable; wherein said first end (101) of the cable is designed to serve as a connecting point (1011) with a charging station (100) and wherein said second end (102) of the cable is designed to serve as a connecting point (1021) with a connector (200).

As stated above, the object of the present invention is also to provide the electric vehicle charging cable (10) that is designed to conduct direct current at a certain value, as described above.

The object of the present invention is also to provide a method of making an electric vehicle charging cable (20) that is designed to conduct alternating current at a certain value that has a neutral line (21) and one or three phase lines (22). The method includes the following:
(a) providing two, three, four or more conductors (23) per each phase line, and providing same number of conductors to serve as the neutral line when the cable is a single-phase line or providing a single conductor or the same number of conductors to serve as the neutral line when the cable is a three-phase lines;
(b) wherein said single conductor or the same number of conductors and said two, three, four or more conductors per each phase line are together capable and appropriate to conduct alternating current at at least said certain value, and wherein said same number of conductors and said two, three, four or more conductors per each phase line are together capable and appropriate to conduct alternating current at at least said certain value;
(c) preparing the cable (20), inter alia, from the two, three, four or more conductors per each phase line together with the same number of conductors or together with the single conductor or the same number of conductors;
(d) wherein a total cross-sectional areas (23a) of the two, three, four or more conductors (23) per each phase line when the cable is the single-phase line is equal or smaller than a total cross-sectional area (24a) of hypothetical conductor (24) that serves as a single phase line that is capable and appropriate to conduct alternating current at said at least certain value;
(e) wherein the total cross-sectional areas (23a) of the two, three, four or more conductors per each phase line when the cable is the three-phase lines is equal or smaller than a total cross-sectional areas (25a) of hypothetical three conductors (25) that serve as three phase lines that together are capable and appropriate to conduct alternating current at said at least certain value;
(f) wherein a total weight of the two, three, four or more conductors per each phase line of a given length when the cable is the single-phase line is equal or smaller than a total weight of the hypothetical conductor that serve as the single phase line of said given length;
(g) wherein a total weight of the two, three, four or more conductors per each phase line of a given length when the cable is the three-phase lines is equal or smaller than a total weight of the hypothetical three conductors that serve as the three phase lines of said given length;
(h) wherein a steady state temperature of the two, three, four or more conductors per each phase line while transmitting certain level of current for certain period of time when the cable is the single-phase line is lower than hypothetical steady state temperature of the hypothetical conductor that serves as the single-phase line while transmitting said certain level of current for said certain period of time;
(i) wherein a steady state temperature of the two, three, four or more conductors per each phase line while transmitting certain level of current for certain period of time when the cable is the three-phase line is lower than hypothetical steady state temperature of the hypothetical three conductors that serve as the three-phase lines while transmitting said certain level of current for said certain period of time;
(j) wherein first ends (231) of said two, three, four or more conductors per each phase line are connected together at a first end (201) of the cable and second ends (232) of said two, three, four or more conductors per each phase line are connected together at a second end (202) of the cable; wherein said first end of the cable is designed to serve as a connecting point (2011) with a charging station (100) and wherein said second end of the cable is designed to serve as a connecting point (2021) with a connector (200).

As stated above, the object of the present invention is also to provide electric vehicle charging cable (20) that is designed to conduct alternating current at a certain value that has a neutral line and one or three phase lines, as described above.

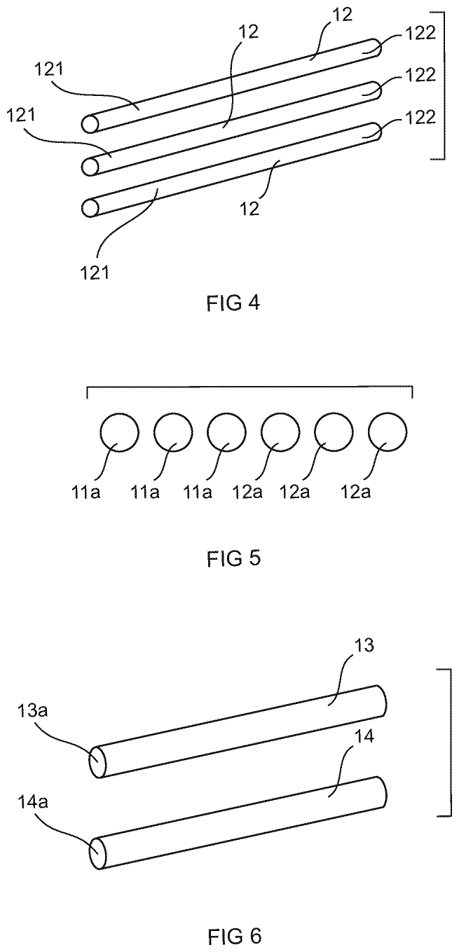

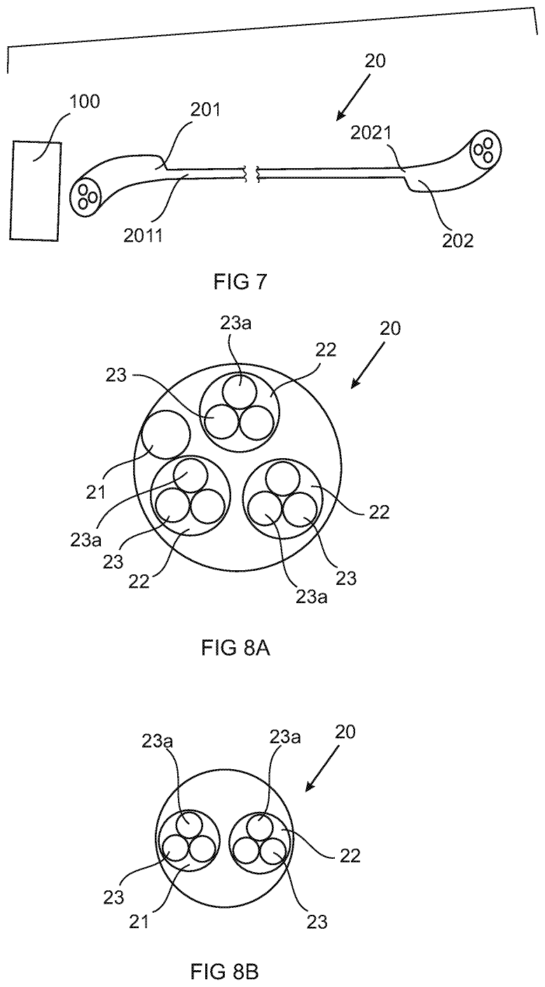

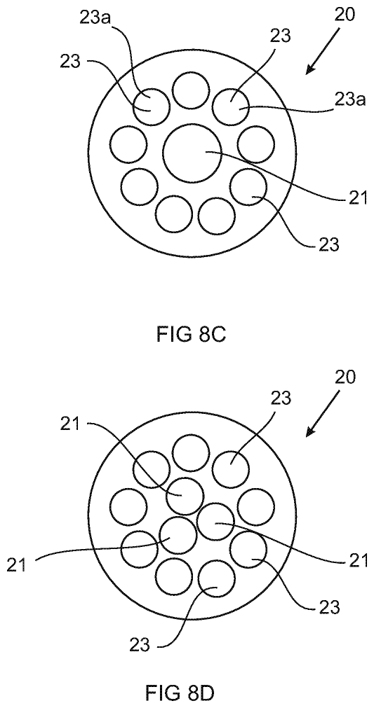

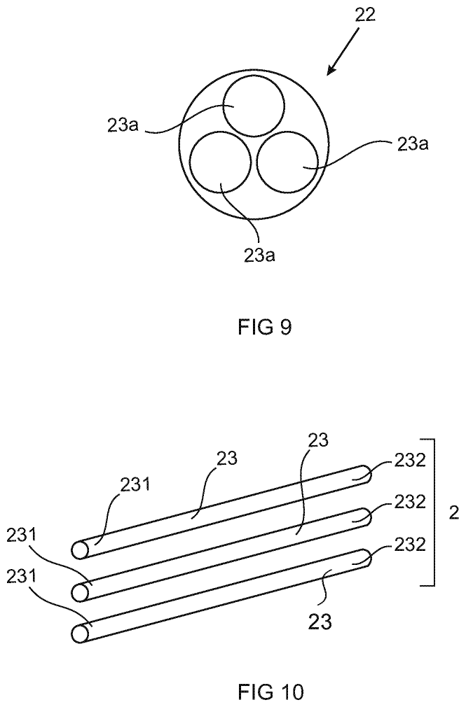

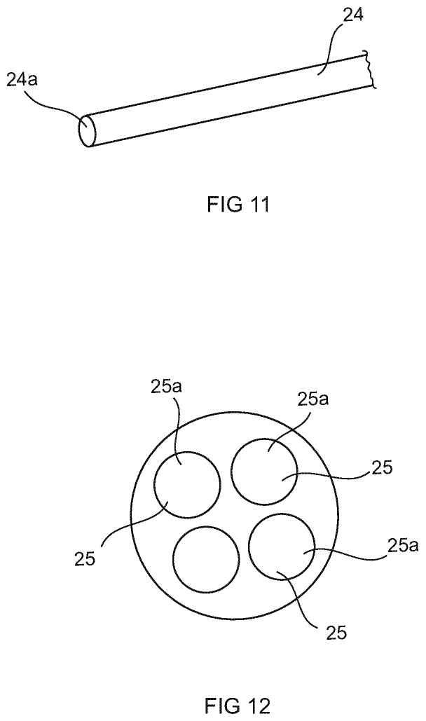

FIG. 2 schematically illustrates the cable 10. FIG. 3 schematically illustrates three positive conductors 11. FIG. 4 schematically illustrates three negative conductors 12. FIG. 5 schematically illustrates the cross sectional areas 11a and 12a. FIG. 6 schematically illustrates the hypothetical single positive and negative conductors 13 and 14 and their cross sectional areas 13a and 14a. FIG. 7 schematically illustrates the cable 20. FIGS. 8A, 8C and 8D schematically illustrate a cross section of the cable 20 when it is a three-phase line. FIG. 8B schematically illustrates a cross section of the cable 20 when it is a single-phase line. FIG. 9 schematically illustrates a cross section of a phase line 22. FIG. 10 schematically illustrates three conductors 23. FIG. 11 schematically illustrates the hypothetical conductor 24 and its cross-sectional area 24a. FIG. 12 illustrates a cross section of a standard three-phase line cable.

1: A method of making an electric vehicle charging cable that is designed to conduct direct current at a certain value, comprising:
(a) providing two, three, four or more conductors that serve as positive conductors and two, three, four or more conductors that serve as negative conductors, wherein said positive conductors when are connected together to each other at their ends and said negative conductors when are connected together to each other at their ends, are capable to conduct direct current at said certain value;
(b) wherein a total cross-sectional areas of the positive conductors and of the negative conductors is equal to or smaller than a total cross-sectional areas of hypothetical single positive conductor and single negative conductor that are capable to conduct direct current at said certain value;
(c) wherein a total weight of the positive conductors and of the negative conductors at a given length is equal 1 or smaller than a total weight of aid hypothetical single positive conductor and single negative conductor of at said given length;
(d) connecting together to each other first ends of the positive conductors at a first end of the electric vehicle charging cable and connecting together to each other second ends of the positive conductors at a second end of the electric vehicle charging cable;
(c) connecting together to each other first ends of the negative conductors at said first end of the electric vehicle charging cable and connecting together to each other second ends of the negative conductors at said second end of the electric vehicle charging cable;
(f) wherein said first end of the cable is designed to be connected to a charging station and said second end of the cable is connected to a charging connector that is designed to communicate with a socket of an electrical cars.

2: An electric vehicle charging cable that is designed to conduct direct current at a certain value that comprises two, three, four or more conductors that serve as positive conductors and two, three, four or more conductors that serve as negative conductors;
wherein said positive conductors when are connected to each other at their ends and said negative conductors when are connected to each other at their ends, are capable to conduct direct current at said certain value;
wherein a total cross-sectional areas of the positive conductors and of the negative conductors is equal to or smaller than a total cross-sectional areas of a hypothetical single positive conductor and single negative conductor that are capable to conduct direct current at said certain value;
wherein a total weight of the positive conductors and of the negative conductors at a given length is equal to or smaller than a total weight of said hypothetical single positive conductor and said single negative conductor at said given length;
wherein first ends of said positive conductors are connected together to each other at a first end of the electric vehicle charging cable and second ends of said positive conductors are connected together to each other at a second end of the electric vehicle charging cable;
wherein first ends of said negative conductors are connected together to each other at said first end of the electric vehicle charging cable and second ends of said negative conductors are connected together to each other at said second end of the electric vehicle charging cable;
wherein said first end of the cable is designed to be connected to a charging station and said second end of the cable is connected to a charging connector that is designed to communicate with a socket of an electrical cars.

3: A method of making a three-phase-lines electric vehicle charging cable that is designed to conduct alternating current at a certain value, comprising:
(a) providing two, three, four or more conductors per each phase line and one or more conductors that serve as a neutral line; wherein said neutral line, and said two, three, four or more conductors of said three phase lines when said conductors of each phase line are connected together to each other at their ends, are capable to conduct alternating current at said certain value;
(b) wherein a total cross-sectional areas of the two, three, four or more conductors of said three phase lines is equal to or smaller than a total cross-sectional areas of hypothetical three single conductors that serve as three phase lines that together are capable to conduct alternating current at said certain value;
(c) wherein a total weight of the two, three, four or more conductors of said three phase lines at a given length is equal to or smaller than a total weight of the hypothetical three sing conductors that serve as the three phase lines at said given length;
(d) connecting together to each other first ends of the two, three, four or more conductors per f each phase line at a first end of the cable and connecting together to each other second ends of the two, three, four or more conductors of each phase line at a second end of the cable;
(e) wherein said first end of the cable is designed to be connected to a charging station and said second end of the cable is connected to a charging connector that is designed to communicate with a socket of an electric car.

4: A three-phase-lines electric vehicle charging cable that is designed to conduct alternating current at a certain value that comprises two, three, four or more conductors per each phase line, and one or more conductors that serve as a neutral line;
wherein said two, three, four or more conductors of said phase lines when said conductors of each phase line are conned together to each other at their ends and the neutral line, are capable to conduct alternating current at said certain value;
wherein a total cross-sectional areas of the two, three, four or more conductors of said three phase lines is equal to or smaller than a total cross-sectional areas of a hypothetical three single conductors that serve as three-phase-lines that is r capable to conduct alternating current at said at-least certain value;
wherein a total weight of the two, three, four or more conductors of said three phase lines at a given length is equal 4 or smaller than a total weight of the hypothetical three single conductors that serve as the three phase lines of g said given length;
wherein first ends of said two, three, four or more conductors of each phase line are connected together to each other at a first end of the cable and second ends of said two, three, four or more conductors of each phase line are connected together to each other at a second end of the cable;
wherein said first end of the cable is designed to be connected to a charging station and said second end of the cable is connected to a charging connector that is designed to communicate with a socket of an electric car.

5: A method of making a single-phase-line electric vehicle charging cable that is designed to conduct alternating current at a certain value, comprising:
(a) providing two, three, four or more conductors that serve as the single phase line and one or more conductors that serve as a neutral line, wherein the two, three, four or more conductors of the single phase line when the conductors are connected together to each other at their ends and the neutral line, are capable to conduct alternating current at said certain value;
(b) wherein a total cross-sectional areas of the two, three, four or more conductors of the single phase line is equal to or smaller than a total cross-sectional area of hypothetical single conductor that serve as a single phase line that is capable to conduct alternating current at said certain value;
(c) wherein a total weight of the two, three, four or more conductors of said single phase line at a given length is equal to or smaller than a total weight of the hypothetical single conductor that serve as the single phase lines at said given length;
(d) connecting together to each other first ends of the two, three, four or more conductors of the single phase line at a first end of the cable and connecting together to each other second ends of the two, three, four or more conductors of the single phase line at a second end of the cable; and
(e) wherein said first end of the cable is designed to be connected to a charging station and said second end of the cable is designed to be connected to a charging connector that is designed to communicate with a socket of an electric car.

6: A single-phase-lines electric vehicle charging cable that is designed to conduct alternating current at a certain value that comprises two, three, four or more conductors that serve as the single phase line, and one or more conductors that serve as a neutral line;
wherein said two, three, four or more conductors of said single phase line when said conductors are connected together to each other at their ends and the neutral line, are capable to conduct alternating current at said certain value;
wherein a total cross-sectional areas of the two, three, four or more conductors of the single phase line is equal to or smaller than a total cross-sectional areas of hypothetical single conductor that serve as a single-phase-line that is capable to conduct alternating current at said certain value;
wherein a total weight of the two, three, four or more conductors of the single phase line at a given length is equal to or smaller than a total weight of the hypothetical single conductor that serve as the single phase line at said given length;
wherein first ends of said two, three, four or more conductors of the single phase line are connected together to each other at a first end of the cable and second ends of said two, three, four or more conductors of the single phase line are connected together to each other at a second end of the cable; and
wherein said first end of the cable is designed to be connected to a charging station and said second end of the cable is designed to be connected to a charging connector that is designed to communicate with a socket of an electric car.
